(19) United States
(12) Patent Application Publication
(10) Pub. No.: US 2007/0098153 A1
(43) Pub. Date: May 3, 2007

(54) CRYPTOGRAPHIC PROCESSING APPARATUS

(75) Inventor: Shigeru NISHIKAWA, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/467,699

(22) Filed: Aug. 28, 2006

(30) Foreign Application Priority Data
Aug. 31, 2005 (JP) 2005-252483 (PAT.
Jul. 3, 2006 (JP) 2006-183850 (PAT.

(51) Int. Cl. H04L 9/30

(52) U.S. Cl. 380/30

(57) ABSTRACT

A cryptographic processing apparatus includes a holding unit adapted to hold data of a processing target, an intermediate data holding unit adapted to hold information generated during the cryptographic processing as intermediate data, a circuit reconfiguration processor which reconfigures a first circuit which generates round key information on the basis of the intermediate data and/or the key information, in accordance with input of first control information, and reconfigures a second circuit which performs operation processing on the basis of the data and/or the intermediate data and the round key information, in accordance with input of second control information, and a control unit adapted to output the first control information to the circuit reconfiguration processor at a first timing, and output the second control information to the circuit reconfiguration processor at a second timing.

### BACKGROUND OF THE INVENTION

1. Field of the Invention

The present invention relates to a technique of encrypting/decrypting data.

2. Description of the Related Art

With recent advances in information technology and network technology, there have been increasing needs for the attainment of security (safety) of information. As a technique for attaining security of information, a cryptographic technique of encrypting/decrypting data on the basis of a predetermined cryptographic scheme is known. Cryptographic schemes are roughly classified into common key cryptosystems (private key cryptosystems) and public key cryptosystems.

The former (common key cryptosystem) is a cryptographic scheme in which an encryption key used for encryption is identical (common) to a decryption key used for decryption. In an arrangement using a common key cryptosystem, the side where data is encrypted and the side where the encrypted data is decrypted need to share the same key in advance. For this reason, a system using the common key cryptosystem demands a mechanism of safely realizing key sharing and management.

The latter (public key cryptosystem) is a cryptographic scheme in which a key used for encryption differs from a key used for decryption. In an arrangement using the public key cryptosystem, two different keys as public and private keys are prepared in advance for each data decryption side. A public key is a key serving as an encryption key used for the encryption of data and is disclosed in the system. A private key is a key serving as a decryption key used for the decryption of data, and is secretly managed on the data decryption side. In a system using the public key cryptosystem, data is encrypted by using a disclosed public key of a communication partner at the time of encryption. At the time of decryption, the decryption side performs decryption by using its own private key.

In the public key cryptosystem, it is difficult to mathematically obtain a decryption key from a public key. For this reason, in a system using the public key cryptosystem, the data decryption side maintains the security of the system by only secretly managing its own private key.

However, the calculation cost required for encryption/decryption in the common key cryptosystem is much lower than that in the public key cryptosystem. In other words, operation by the common key cryptosystem is much faster than that by the public key cryptosystem.

As typical schemes based on the common key cryptosystem, there are known DES which has been widely used as a practical standard and Rijndael which has been selected as a standard 128-bit common key block encryption AES in the US by NIST (National Institute of Standards and Technology). Note that DES stands for Data Encryption Standard. AES stands for Advanced Encryption Standard.

Basic processing in DES and AES is simple, and is configured to repeatedly execute data transformation processing called a round function a predetermined number of times. In AES, four elementary operations (ShiftRows, SubBytes, MixColumns, and AddRoundKey) are repeated for 128-bit (16-byte) input data a number of times. The round count changes depending on the length of the key. The round count is set to 11 for a 128-bit key; 13 for a 192-bit key; and 15 for a 256-bit key.

In ShiftRows as a basic operation in AES, data is regarded as a 4-byte×4-byte matrix, and each row is cyclically shifted by 0 to 3 bytes.

In SubBytes, each byte of data is transformed into an inverse element of a 2⁸ Galois field GF(2⁸), and matrix transformation called affine transformation is further performed for the resultant data. SubBytes is mapping from a given byte into another byte, and can be expressed as a truth table.

In MixColumns, each column of the above matrix is regarded as a cubic polynomial having each element as a coefficient, and the polynomial is multiplied by a polynomial of {03}₁₆X³+{01}₁₆X²+{01}₁₆X+{02}₁₆ where {k}ₙ represents a value k expressed in base n. The remainder of the division between the polynomial obtained by multiplication and X⁴+1is obtained, and four coefficients of the resultant polynomial are output.

In AddRoundKey, the XOR between data and a round key generated from a private key is calculated.

Such encryption/decryption processing requires a predetermined operation load. For this reason, depending on application purposes, conventional arrangements are implemented by hardware when importance is attached to throughput (processing speed) and reduction in power consumption and implemented by software when importance is attached to cost and flexibility rather than throughput.

When an AES processing arrangement is implemented by software on an x86 processor, some contrivance can be made by making use of ability to use a large memory, e.g., holding operation for round functions as a table in memory in advance and calculating a round key in advance. In this case, a cycle count of about 350 can be obtained with a clock frequency of 800 MHz, and a throughput of about 360 Mbps can be achieved. However, since the CPU generally performs processing other than cryptographic processing, the throughput becomes several ten to several hundred Mbps in practice. When performance higher than 1 Gbps is required, hardware must inevitably implement the above arrangement.

According to AES, 128-bit data is computed by a round function in the form of a set of four 32-bit functions. For this reason, when AES is implemented by hardware and one-round processing is performed 32 bits by 32 bits using a plurality of clocks, the circuit size decreases even though the cycle count increases. When one-round processing is performed by 32 bits by 32 bits using one clock, the circuit size increases even though the cycle count decreases. If, for example, one round is processed by one clock, the cycle count becomes 11, the circuit size is equivalent to about 30,000 gates, and the throughput becomes about 2 to 3 Gbps. When one round is processed by four clocks, the cycle count becomes 44, the circuit size is equivalent to about 10,000 gates, and the throughput becomes about 500 Mbps.

A conventional hardware arrangement which executes AES encryption/decryption will be described with reference to FIG. 7. FIG. 7 exemplifies the conventional hardware arrangement of an AES encryption/decryption circuit.

Referring to FIG. 7, reference numeral 800 denotes the range of an AES encryption/decryption circuit; 801, an input data round processing circuit 802, a key data round processing circuit; 803, a 2:1 selector circuit; 804, a Data Register; 805, a SiftRows/InvShiftRows circuit; 806, a SubBytes/InvSubBytes circuit; 807, a MixColumns/InvMixColumns circuit; 808, a 3:1 selector circuit; 809, an AddRoundKey circuit; and 810, a KeyExpander circuit.

Note that InvShiftRows means an inverse function of ShiftRows, InvSubBytes means an inverse function of SubBytes, and InvMixColumns means an inverse function of MixColumns. Each of the circuits 805, 806, and 807 is implemented by one circuit designed to switch between positive and inverse functions. For this reason, the circuits 805, 806, and 807 will be referred to as ShiftRows, SubBytes, and MixColumns.

The highest processing load portion of an AES round function implemented by the above constituent elements is a portion associated with nonlinear transformation processing of the SubBytes/InvSubBytes 806 which is called an S-Box. Implementing 128-bit data round processing by one clock requires 16 one-byte SubBytes. For this reason, an arrangement which implements SubBytes influences throughput, area, and power consumption.

The circuit arrangements of SubBytes are roughly classified into an arrangement implemented as a combinational circuit corresponding to a truth table for SubBytes and an arrangement implemented as a circuit obtained by series-connecting an inverse element computing circuit and an affine transformation circuit.

A combinational circuit corresponding to a truth table can be implemented as a circuit in a sum-of-products form or a single-stage or multi-stage AND-XOR circuit, and can be designed by, for example, automatic synthesis using a logical synthesis tool.

An inverse element computing circuit can be formed by a sequential circuit on a Galois field GF(2⁸) by using the property represented by inverse element X⁻¹=X²⁵⁴ of an arbitrary value X. That is, an inverse element can be obtained by calculating the 254th power on the Galois field GF(2⁸). If, however, multiplication is performed by simply performing looping operation 254 times, the clock cycle greatly increases, and the output delay increases. As a method of configuring an inverse element computing circuit, Itoh and Tsujii's algorithm which implements inverse element computation by three looping operations.

The circuit size and output delay of a SubBytes circuit greatly vary depending on its arrangement. For example, in an automatically synthesized circuit, the output delay is small, but the circuit size becomes as large as just slightly under 3,000 gates. In contrast, in an arrangement in which an inverse element computing circuit is implemented by Itoh and Tsujii's algorithm, although the output delay is slightly large, the circuit size becomes relatively small, i.e., little under 2,000 gates.

When hardware implements AES, the values of evaluation items, e.g., speed, circuit size, and power consumption, greatly depend on the circuit arrangement. For this reason, according to conventional designs, a circuit arrangement for SubBytes has been selected and designed so as to preferentially satisfy any specifications of the required specifications for speed, circuit size, power consumption, and the like in accordance with an application purpose.

As another conventional example, Japanese Patent Application Laid-Open No. 7-199807 discloses a technique of realizing high-speed processing for modular multiplication with a small-size circuit. According to this element, cascading a plurality of small-size computing elements to perform pipeline processing allows to achieve high-speed modular multiplication for encryption with a small-size circuit. Note that modular multiplication is used for some of the common cryptographies using random numbers and public key cryptosystems such as a RAS cryptography and ElGamal cryptography.

Conventionally, an FPGA (Field Programmable Gate Array) is known as a device which can change a circuit arrangement. An FPGA is an LSI which can be reconfigured into various functions by using a primitive circuit comprising a lookup table and the like as a unit. Note, however, that the FPGA generally requires about one minute to rewrite a circuit arrangement, and does not allow dynamic reconfiguration for each clock.

In contrast to this, recently, a dynamic reconfigurable processor (dynamic reconfiguration processor or circuit reconfiguration processor) is known, which is capable of rewriting an internal arrangement within a very short period of time. A circuit reconfiguration processor can rewrite a circuit arrangement within each clock with, for example, a period of 6 ns by setting a computing circuit with a certain circuit size, e.g., a multiplier, as a circuit unit to be reconfigured, and devising some technique for increasing the processing speed.

As described above, AES encryption/decryption processing is implemented by software to obtain a low-cost system. However, such a system can be implemented only with a predetermined processing speed or less by software processing by a CPU, and hence a desired requirement cannot be satisfied depending on a required encryption/decryption processing speed in some case. In addition, software processing by the CPU requires more power consumption than a system implemented by hardware.

When such a system is implemented by hardware, the processing speed can increase depending on the hardware, and the power consumption is lower than that in software processing by the CPU. Even with the above techniques for circuit size reduction, a required encryption processing speed cannot be satisfied. In addition, depending on an encryption/decryption algorithm, a large gate size as hardware is required, resulting in an increase in chip cost.

As described above, depending on conventional arrangements, there are tradeoffs between requirements for an increase in processing speed, a reduction in power consumption, and a reduction in gate size.

### SUMMARY OF THE INVENTION

The present invention has been made in consideration of the above problems, and has as its object to provide a technique associated with an encryption/decryption processing circuit which can satisfy requirements for high-speed processing, low power consumption, and small gate size.

In order to achieve the above object, an cryptographic processing apparatus according to the present invention includes the following arrangement.

There is provided a cryptographic processing apparatus which executes predetermined cryptographic processing for data, comprising a holding unit adapted to hold the data of a processing target, an intermediate data holding unit adapted to hold information generated during the cryptographic processing as intermediate data, a circuit reconfiguration processor which reconfigures a first circuit which generates round key information on the basis of at least one of the intermediate data and the key information, in accordance with input of first control information, and reconfigures a second circuit which performs operation processing on the basis of at least one of the data and the intermediate data and the round key information, in accordance with input of second control information, and a control unit adapted to output the first control information to the circuit reconfiguration processor at a first timing, and output the second control information to the circuit reconfiguration processor at a second timing, wherein the intermediate data includes at least one of the round key information generated in the first circuit and data of a result of operation processing performed in the second circuit, and the data of the result of the operation processing performed in the second circuit is output as a result of cryptographic processing.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a flowchart showing the flow of basic processing executed by a cryptographic processing apparatus according to the first to third embodiments;

FIG. 2 is a view showing the arrangement of the main part of the cryptographic processing apparatus according to the first embodiment;

FIG. 3 is a block diagram showing the internal arrangement of the cryptographic processing apparatus according to the first embodiment;

FIG. 4 is a flowchart showing the flow of operation of an arrangement according to the first embodiment;

FIG. 5 is a block diagram showing the internal arrangement of a cryptographic processing apparatus according to the second embodiment;

FIG. 6 is a flowchart showing the flow of processing in the arrangement according to the second embodiment;

FIG. 7 is a view exemplifying the conventional hardware arrangement of an AES encryption/decryption circuit;

FIG. 8 is a view showing the arrangement of the main part of a cryptographic processing according to the third embodiment; and

FIG. 9A and 9B are views exemplifying pieces of information stored in storage units.

### DESCRIPTION OF THE EMBODIMENTS

The embodiments of the present invention will be described in detail below with reference to the accompanying drawings. Note, however, that the constituent elements described in these embodiments are merely examples, and the scope of the present invention is not limited to only them.

<<First Embodiment>>

This embodiment is directed to a cryptographic processing apparatus which executes a series of cryptographic processes comprising a plurality of processing steps. The cryptographic processing apparatus according to this embodiment dynamically reconfigures each cryptographic processing circuit in each processing interval for each of two or more cryptographic processing steps with different execution intervals by using the same dynamic reconfiguration means (circuit reconfiguration processor), thereby implementing each cryptographic processing step. That is, the respective independent cryptographic processing circuits in the conventional arrangement are implemented by time-divisionally using one circuit reconfiguration processor in the arrangement according to this embodiment. This makes it possible to achieve a reduction in circuit size and satisfy requirements for high performance (high processing speed), low power consumption, and low cost (small gate size).

(Basic Processing)

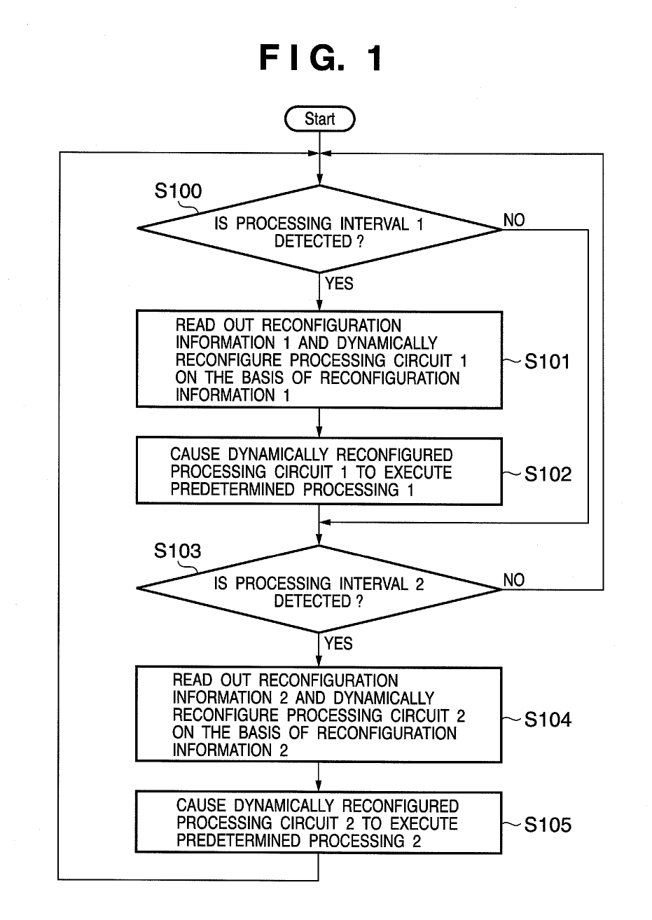

Basic processing executed by an encryption circuit as a cryptographic processing apparatus according to this embodiment will be described first with reference to FIG. 1. FIG. 1 is a flowchart showing the flow of basic processing executed by the cryptographic processing apparatus according to this embodiment. FIG. 1 shows, for example, an operation flow in a case wherein predetermined processes (to be referred to as processes 1 and 2) are executed in two different processing intervals (to be referred to as processing intervals 1 and 2).

First of all, in step S100, it is determined whether the timing of processing interval 1 is detected. If the timing is detected (YES in step S100), the flow advances to step S101. If the timing is not detected (NO in step S100), the flow advances to step S103.

In step S101, reconfiguration information 1 for processing interval 1 is read out from a reconfiguration information storage unit 203 under the control of a control unit 202 (to be described later). A processing circuit 1 is dynamically reconfigured into a dynamic reconfiguration circuit 201 (to be described later) on the basis of readout reconfiguration information 1.

In step S102, the processing circuit 1 dynamically configured in step S101 executes predetermined process 1, and the flow advances to step S103.

In step S103, it is determined whether the timing of processing interval 2 is detected. If the timing is detected (YES in step S103), the flow advances to step S104. If the timing is not detected (NO in step S103), the flow advances to step S100.

In step S104, reconfiguration information 2 for processing interval 2 is read out from the reconfiguration information storage unit 203 under the control of the control unit 202. A processing circuit 2 is dynamically reconfigured into the dynamic reconfiguration circuit 201 on the basis of readout reconfiguration information 2.

In step S105, the processing circuit 2 which is dynamically configured in step S104 executes predetermined process 2, and the flow returns to step s100.

(Basic Arrangement)

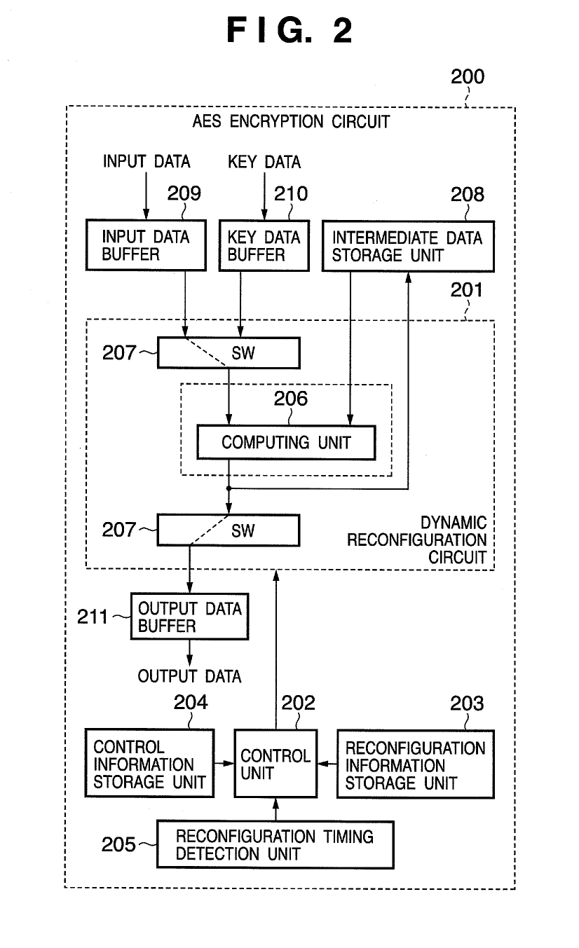

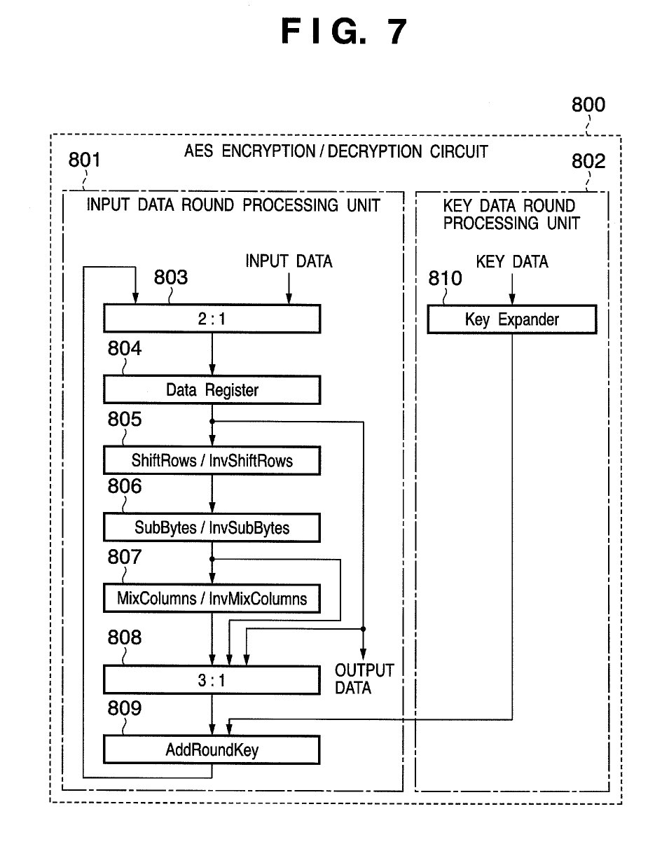

This embodiment exemplifies a case wherein a dynamic reconfiguration means is applied to an AES encryption circuit to dynamically reconfigure different processing circuits for the first and second halves of a round processing period, thereby achieving a reduction in circuit size. FIG. 2 is a block diagram showing the arrangement of the main part of the encryption circuit as the cryptographic processing apparatus according to this embodiment. Note that the same reference numerals as in FIG. 7 denote common parts.

Referring to FIG. 2, reference numeral 201 denotes the dynamic reconfiguration circuit; 202, the control unit of the dynamic reconfiguration circuit; 203, the reconfiguration information storage unit storing the information of a circuit for dynamic reconfiguration; 204, a control information storage unit which stores control programs for the control unit; and 205, a reconfiguration timing detection unit.

The dynamic reconfiguration circuit 201 comprises a dynamically reconfigurable processor array and the like, and functions as a circuit reconfiguration processor. The control unit 202 comprises a general CPU and the like. The dynamic reconfiguration circuit 201 comprises a reconfigurable computing unit 206 and a switch (to be referred to as an SW hereinafter) 207 which switches connection.

The reconfiguration information storage unit 203 and control information storage unit 204 comprise nonvolatile memories such as general flash memories. In this embodiment, the reconfiguration timing detection unit 205 detects the start timings of the first and second halves of a round processing period.

Reference numeral 208 denotes an intermediate data storage unit which stores the processing result obtained by the dynamic reconfiguration circuit 201 and loads the stored data (processing result) into the dynamic reconfiguration circuit 201 when next reconfiguration is performed; 209, an input data buffer which stores input data to be encrypted or decrypted; 210, a key data buffer which stores key data when encryption or decryption is performed; and 211, an output data buffer which stores the output data generated by encrypting or decrypting input data.

The intermediate data storage unit 208, input data buffer 209, key data buffer 210, and output data buffer 211 each comprise a volatile memory such as an SRAM or a volatile memory such as a DRAM.

(Operation of Cryptographic Processing Apparatus)

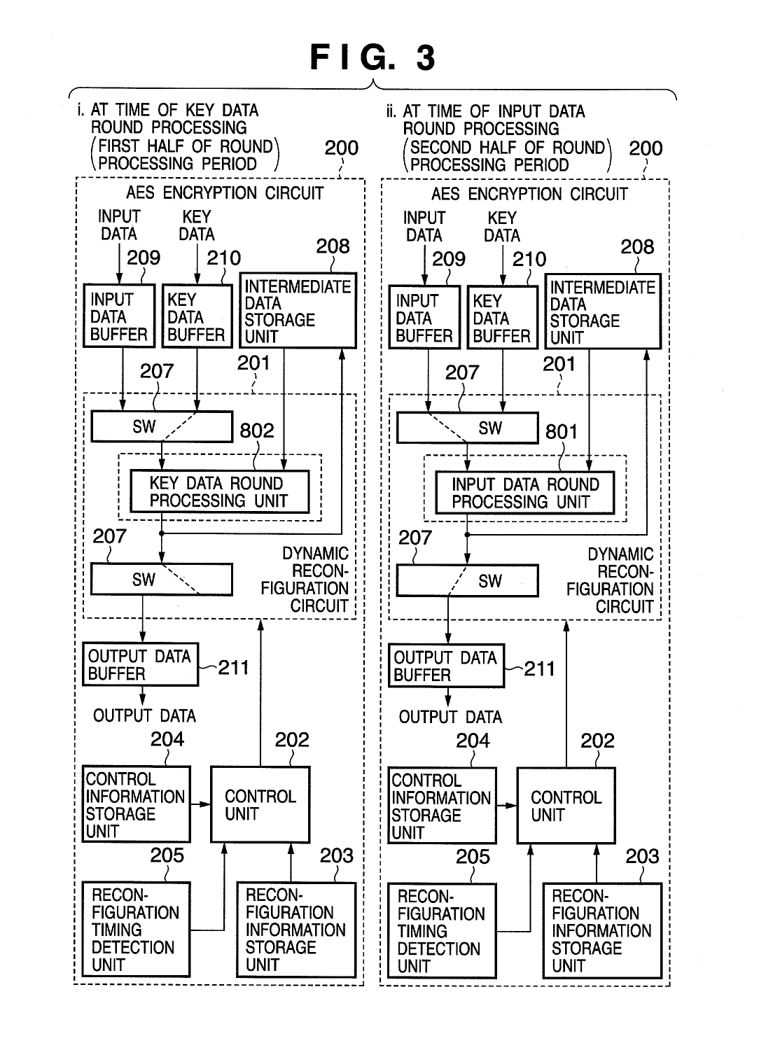

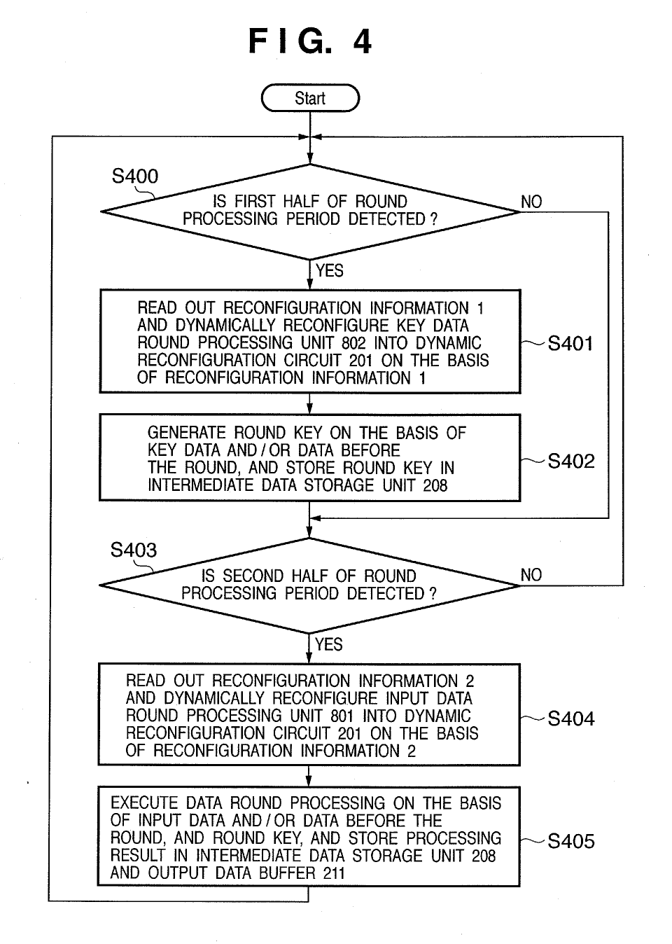

The operation of the encryption circuit as the cryptographic processing apparatus according to this embodiment will be described next with reference to FIGS. 3 and 4.

FIG. 3 is a block diagram showing the internal arrangement of the encryption circuit as the cryptographic processing apparatus according to this embodiment. The embodiment will exemplify a circuit for performing AES encryption as a cryptographic processing apparatus. However, the present invention is not limited to this. For example, the arrangement of the embodiment can be applied to AES decryption. In addition, the embodiment can be applied to other encryption/decryption circuits such as DES circuits. In the encryption circuit exemplified in FIG. 3, a key data round processing unit and an input data round processing unit are respectively dynamically reconfigured for the first and second halves of a round processing period in the portion of the dynamic reconfiguration circuit 201.

FIG. 4 is a flowchart showing the flow of operation of the arrangement according to this embodiment.

First of all, in step S400, the control unit 202 determines whether the start timing of the first half of a round processing period is detected by the reconfiguration timing detection unit 205. If the timing is detected (YES in step S400), the flow advances to step S401. If the timing is not detected (NO in step S400), the flow advances to step S403. Note that when detecting the start timing of the first half of a round processing period, the reconfiguration timing detection unit 205 notifies the control unit 202 of information indicating the detection of the timing by an interrupt or the like. The control unit 202 performs determination in step S400 on the basis of this information.

In step S401, the control unit 202 reads out the reconfiguration information for a key data round processing unit 802 from the reconfiguration information storage unit 203. The control unit 202 controls the computing unit 206 and SW 207 of the dynamic reconfiguration circuit 201 to dynamically configure the key data round processing unit 802 into the dynamic reconfiguration circuit 201 on the basis of the readout reconfiguration information.

In step S402, as in the processing in the arrangement shown in FIG. 7, the control unit 202 performs control to input at least key data in the key data buffer 210 or data before the round which is stored in the intermediate data storage unit 208 to the key data round processing unit 802. The control unit 202 controls the key data round processing unit 802 to generate a round key for the round on the basis of the input data, and to store the generated round key in the intermediate data storage unit 208. The flow then advances to step S403.

In step S403, the control unit 202 determines whether the start timing of the second half of the round processing period is detected by the reconfiguration timing detection unit 205. If the timing is detected (YES in step S403), the flow advances to step S404. If the timing is not detected (NO in step S403), the flow returns to step S400. Note that, as in the processing in step S400, when detecting the start timing of the second half of the round processing period, the reconfiguration timing detection unit 205 notifies the control unit 202 of information indicating the detection of the timing by an interrupt or the like. The control unit 202 performs decision in step S403 on the basis of this information.

In step S404, the control unit 202 reads out the reconfiguration information for the input data round processing unit 801 from the reconfiguration information storage unit 203 on the basis of a program stored in the control information storage unit 204. The control unit 202 controls the computing unit 206 and SW 207 of the dynamic reconfiguration circuit 201 so as to dynamically configure the input data round processing unit 801 into the dynamic reconfiguration circuit 201 on the basis of the readout reconfiguration information.

In step S405, as in the processing in the arrangement shown in FIG. 7, the control unit 202 controls to input predetermined data to the input data round processing unit 801. That is, the control unit 202 performs control to input at least input data in the input data buffer 209 or data before the round which is stored in the intermediate data storage unit 208, and a round key for the round which is generated in step S402. The control unit 202 further controls the input data round processing unit 801 to execute data round processing for the round on the basis of the input data and store the processing result in the intermediate data storage unit 208 and output data buffer 211. The flow then returns to step S400.

As described above, in the arrangement according to this embodiment, the key data round processing unit and the input data round processing unit are dynamically reconfigured in the first and second halves of a round processing period of the AES encryption circuit, respectively. According to the arrangement of this embodiment, therefore, the circuit size of the ASIC gate can be greatly reduced as compared with the conventional arrangement.

For example, in a conventional circuit designed to execute only encryption or decryption, a size of about 10,000 ASIC gates is required for a circuit corresponding to a key data round processing unit, and a size of about 30,000 ASIC gates is required for a circuit corresponding to an input data round processing unit. That is, the conventional arrangement requires a total size of about 40,000 (=10000+30000) ASIC gates.

In contrast to this, in the arrangement according to this embodiment, if the dynamic reconfiguration circuit has a size of about 30,000 ASIC gates, circuits corresponding to both the key data round processing unit and the input data round processing unit in the conventional arrangement can be implemented. Therefore, the arrangement according to this embodiment can implement functions similar to those of the conventional arrangement even if the circuit size is smaller than that of the conventional arrangement by about 10,000 (=40000−30000) ASIC gates.

In addition, for example, a conventional circuit designed to execute both encryption processing and decryption processing by switching them in accordance with an operation mode requires a size of about 65,000 ASIC gates. This is because, a size of about 15,000 ASIC gates is required for a circuit corresponding to a key data round processing unit and a size of about 50,000 ASIC gates is required for a circuit corresponding to an input data round processing unit (about 15000+about 50000=about 65000).

In contrast to this, in the arrangement according to this embodiment, if the dynamic reconfiguration circuit has a size of about 50,000 ASIC gates, it can implement circuits corresponding to both the key data round processing unit and the input data round processing unit in the conventional arrangement. For this reason, the arrangement according to this embodiment can implement functions similar to those of the conventional arrangement even if the circuit size is smaller than that of the conventional arrangement by 15,000 (=65000−50000) ASIC gates.

Note that a processing load of about several MIPSs is imposed on the control unit 202 for controlling the dynamic reconfiguration circuit 201, and a capacity of several kBytes is required for the control information storage unit 204 and reconfiguration information storage unit 203. As described above, the dynamic reconfiguration circuit can be easily mounted for the control unit, control information storage unit, and data storage unit of the apparatus including the AES encryption circuit 200, and hence does not become a factor that causes an increase in circuit size.

Consider a case wherein the required throughput of data encryption is 1 Gbps, and 128-bit data is processed at one round per clock in 11 cycles. In this case, a clock period for one-round processing must be set such that one-round encryption processing is executed within at least 128/(11×1×10⁹)=11.6 ns. Considering that key data round processing and input data round processing are time-divisionally executed in the above one-round processing interval, each step must be executed within a time equal to or less than ½ the processing interval. A recently released high-speed reconfiguration processor operates at a maximum of 166 MHz, and implements reconfiguration at one clock (6 ns). Therefore, using such a high-speed dynamic reconfiguration means makes it possible to dynamically reconfigure different processing circuits for the first and second halves of a round processing period like that described above. Therefore, a throughput of almost 1 Gbps can be realized.

As described above, the arrangement according to this embodiment can achieve a great reduction in circuit size, and at the same time, can execute high-speed processing. In addition, low power consumption can be realized by executing encryption processing by hardware.

Note that the dynamic reconfiguration means used in the arrangement according to this embodiment is not limited to that in the embodiment shown in FIG. 2 as long as the above requirement for high-speed processing can be satisfied. Obviously, therefore, it suffices to use other architectures for the internal arrangement of the dynamic reconfiguration circuit, the arrangements of the control unit and reconfiguration information storage unit, and the like.

In this embodiment, the processing circuits for both the key data round processing unit 802 and the input data round processing unit 801 are dynamically reconfigured in different intervals. However, circuits to be dynamically configured are not limited to them. Obviously, processing circuits corresponding to processing steps, of the steps executed in encryption processing, which are executed in different intervals may be targets for dynamic reconfiguration. For example, in the AES encryption circuit, processing circuits corresponding to two or more different steps, of the steps in input data processing, which are executed in different intervals may be set as targets for dynamic reconfiguration. Note that input data processing includes a ShiftRows step, SubBytes step, MixColumns step, AddRoundKey step, and the like.

This embodiment has exemplified the case wherein input data is encrypted. Obviously, however, the embodiment is equally applicable to a case wherein input data is decrypted or a case wherein encryption and decryption are switched and executed.

In this embodiment, dynamic reconfiguration is switched in the first and second halves of a round processing period. However, a processing period in which dynamic reconfiguration is switched is not limited to this. Obviously, in accordance with two or more different encryption processing steps, of the encryption/decryption processing steps, which are executed in different processing intervals, corresponding processing circuits may be dynamically reconfigured in each processing interval.

In this embodiment, the processing circuits for both the key data round processing unit 802 and the input data round processing unit 801 are dynamically reconfigured in different intervals. This, however, does not necessarily mean that each circuit is dynamically reconfigured entirely. That is, the circuits may be configured as follows. First of all, a common portion between the key data round processing unit 802 and the input data round processing unit 801 is prepared as a common circuit in advance. A difference circuit between the common circuit and the key data round processing unit 802 and a difference circuit between the common circuit and the input data round processing unit 801 may be dynamically reconfigured.

<<Second Embodiment>>

The second embodiment will further exemplify a case wherein a dynamic reconfiguration means serves as an AES encryption circuit to dynamically reconfigure different processing circuits in the first and second halves of a round processing period, thereby achieving a reduction in circuit size.

An arrangement according to this embodiment, like the first embodiment, is designed to dynamically reconfigure a key data round processing unit and an input data encryption processing unit in the first and second halves of a round processing period. In the arrangement according to this embodiment, when input data is to be encrypted, a key data round processing unit for encryption is dynamically reconfigured in the first half of a round period, and an input data encryption round processing unit is dynamically reconfigured in the second half of the round period. When input data is to be decrypted, a key data round processing unit for decryption is dynamically reconfigured in the first half of a round period, and an input data decryption round processing unit is dynamically reconfigured in the second half of the round period. That is, the arrangement according to this embodiment allows to not only dynamically reconfigure a processing circuit for encryption or decryption as needed but also perform processing by switching encryption and decryption according to the situation.

Although this embodiment will exemplify a circuit for performing AES encryption processing as a cryptographic processing apparatus like the first embodiment, the present invention is not limited to this. For example, the embodiment is applicable to other encryption/decryption circuits such as a DES circuit.

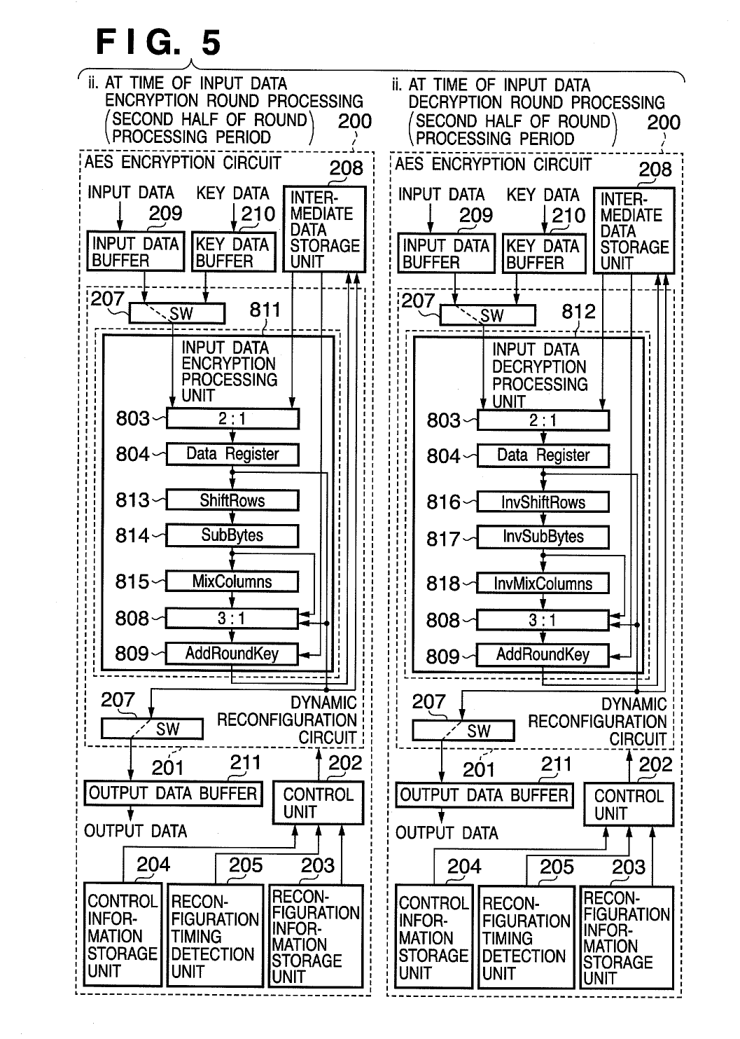

The arrangement of the cryptographic processing apparatus according to this embodiment is basically the same as that of the cryptographic processing apparatus according to the first embodiment. FIG. 5 is a view for explaining operation at the time of input data encryption processing and at the time of decryption processing in the second half of a round processing period. Note that the same reference numerals denote common parts throughout the drawings. Only portions different from those in FIGS. 2 and 7 will be described below.

Referring to FIG. 5, reference numeral 811 denotes an input data encryption processing unit; 813, ShiftRows; 814, SubBytes; 815, MixColumns; 812, an input data decryption processing unit, 816, InvShiftRows; 817, InvSubBytes; and 818, InvMixColumns.

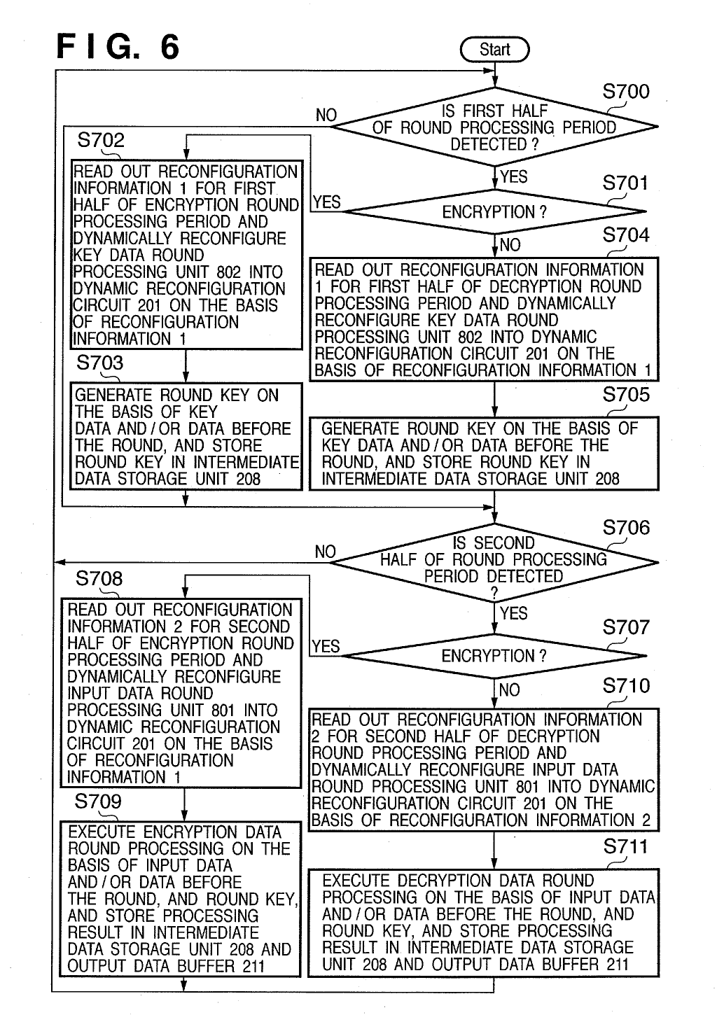

The operation of the arrangement according to this embodiment will be described next with reference FIGS. 5 and 6. FIG. 6 is a flowchart showing the flow of processing in the arrangement according to the embodiment.

First of all, in step S700, a control unit 202 determines whether a reconfiguration timing detection unit 205 detects the start timing of the first half of a round processing period. If the timing is detected (YES in step S700), the flow advances to step S701. If the timing is not detected (NO in step S700), the flow advances to step S706. As in the first embodiment, upon detecting the start timing of the first half of the round processing period, the reconfiguration timing detection unit 205 notifies the control unit 202 of information indicating the detection of the timing by an interrupt or the like. The control unit 202 performs determination in step S700 on the basis of this information.

In step S701, the control unit 202 determines, on the basis of control information (not shown) indicating an operation mode for encryption or decryption, whether the current operation is encryption. If the current operation is encryption (YES in step S701), the flow advances to step S702. If the current operation is not encryption (NO in step S701), the flow advances to step S704. The control information indicating an operation mode for encryption or decryption is input by the user of the cryptographic processing apparatus according to this embodiment or from an external apparatus before the operation.

In step S702, the control unit 202 reads out reconfiguration information for a key data round processing unit 802 from a reconfiguration information storage unit 203 on the basis of a program stored in a control information storage unit 204. The control unit 202 further controls a computing unit 206 and SW 207 of a dynamic reconfiguration circuit 201 on the basis of the readout reconfiguration information, and controls the dynamic reconfiguration circuit 201 to dynamically reconfigure the key data round processing unit 802 for encryption.

In step S703, as in the arrangement shown in FIG. 7, the control unit 202 performs control to input at least key data in a key data buffer 210 or data before the round which is stored in an intermediate data storage unit 208 to the key data round processing unit 802 for encryption. The control unit 202 further controls the key data round processing unit 802 to generate an encryption round key for the round on the basis of the input data and store the generated encryption round key in the intermediate data storage unit 208. The flow then advances to step S706.

In step S704, the control unit 202 reads out reconfiguration information for the key data round processing unit 802 from the reconfiguration information storage unit 203 on the basis of a program stored in the control information storage unit 204. The control unit 202 then controls the computing unit 206 and SW 207 of the dynamic reconfiguration circuit 201 on the basis of the readout reconfiguration information and performs control to dynamically reconfigure the key data round processing unit 802 for decryption into the dynamic reconfiguration circuit 201.

In step S705, as in the arrangement shown in FIG. 7, the control unit 202 performs control to input at least key data in the key data buffer 210 or data before the round which is stored in the intermediate data storage unit 208 to the key data round processing unit 802 for decryption. The control unit 202 further controls the key data round processing unit 802 to generate a decryption round key for the round on the basis of the input data and store the generated decryption round key in the intermediate data storage unit 208. The flow advances to step S706.

In step S706, as in step S700, the control unit 202 determines whether the start timing of the second half of the round processing period is detected by the reconfiguration timing detection unit 205. If the timing is detected (YES in step S706), the flow advances to step S707. If the timing is not detected (NO in step S706), the flow returns to step S700. As in step S700, upon detecting the start timing of the second half of the round processing period, the reconfiguration timing detection unit 205 notifies the control unit 202 of information indicating the detection of the timing by an interrupt or the like. The control unit 202 performs determination in step S706 on the basis of this information.

In step S707, as in step S701, the control unit 202 determines, on the basis of control information (not shown) indicating an operation mode for encryption or decryption, whether the current operation is encryption. If the current operation is encryption (YES in step S707), the flow advances to step S708. If the current operation is not encryption, i.e., is decryption (NO in step S707), the flow advances to step S710. The control information indicating an operation mode for encryption or decryption is input by the user of the cryptographic processing apparatus according to this embodiment or from an external apparatus before the operation.

In step S708, the control unit 202 reads out reconfiguration information for the input data encryption processing unit 811 from the reconfiguration information storage unit 203 on the basis of a program stored in the control information storage unit 204. The control unit 202 further controls the computing unit 206 and SW 207 of the dynamic reconfiguration circuit 201 on the basis of the readout reconfiguration information, and performs control to dynamically reconfigure input data encryption processing unit 811 into the dynamic reconfiguration circuit 201.

In step S709, as in the processing in the arrangement shown in FIG. 7, the control unit 202 performs control to input predetermined data to the input data encryption processing unit 811. That is, the control unit 202.performs control to input at least the input data in the input data buffer 209 or the data before the round which is stored in the intermediate data storage unit 208 and the encryption round key for the round which is generated in step S703. The control unit 202 further controls the input data encryption processing unit 811 to execute data encryption round processing for the round on the basis of the input data and store the processing result in the intermediate data storage unit 208 and an output data buffer 211. The flow then returns to step S700.

In step S710, the control unit 202 reads out reconfiguration information for the input data decryption processing unit 812 from the reconfiguration information storage unit 203 on the basis of a program stored in the control information storage unit 204. The control unit 202 then controls the computing unit 206 and SW 207 of the dynamic reconfiguration circuit 201 on the basis of the readout reconfiguration information and performs control to dynamically reconfigure the input data decryption processing unit 812 into the dynamic reconfiguration circuit 201.

In step S711, as in processing in the arrangement shown in FIG. 7, the control unit 202 performs control to input predetermined data to the input data decryption processing unit 812. The control unit 202 inputs at least the input data in the input data buffer 209 or the data before the round which is stored in the intermediate data storage unit 208 and the decryption round key for the round which is generated in step S705. The control unit 202 further controls the input data decryption processing unit 812 to execute data encryption round processing for the round on the basis of the input data and store the processing result in the intermediate data storage unit 208 and output data buffer 211. The flow then returns to step S700.

As described above, the arrangement according to this embodiment is designed to dynamically reconfigure a key data round processing unit and an input data processing unit in the first and second halves of a round processing period in the AES encryption circuit, respectively. In addition, the key data round processing unit and input data processing unit are dynamically reconfigured into circuits dedicated to each of the operation modes for encryption and decryption. This makes it possible to further reduce the circuit size as compared with the arrangement of the first embodiment.

For example, the conventional circuit designed to execute both encryption processing and decryption processing upon switching them in accordance with an operation mode requires a size of about 65,000 ASIC gates. In contrast, the arrangement according to this embodiment can implement functions similar to those of the conventional arrangement if the dynamic reconfiguration circuit has a size of about 30,000 ASIC gates.

As described in the first embodiment, the circuit sizes required for encryption or decryption are: a size of about 10,000 ASIC gates for a circuit corresponding to the key data round processing unit, and a size of about 30,000 ASIC gates for a circuit corresponding to input data round processing unit. Therefore, in the arrangement according to this embodiment, if the dynamic reconfiguration circuit has a size of about 30,000 ASIC gates, these circuits can be switched and implemented. As described above, the arrangement according to this embodiment can implement functions similar to those of the conventional arrangement even if the circuit size is smaller than that of the conventional arrangement by about 35,000 (=65000−30000) ASIC gates.

Note that a processing load of about several MIPSs is imposed on the control unit 202 for controlling the dynamic reconfiguration circuit 201, and a capacity of several kBytes is required for the control information storage unit 204 and reconfiguration information storage unit 203. As described above, the dynamic reconfiguration circuit can be easily mounted for the control unit, control information storage unit, and data storage unit of the apparatus including an AES encryption circuit 200, and hence does not become a factor that causes an increase in circuit size.

Consider a case wherein the required throughput of data encryption is 1 Gbps, and 128-bit data is processed at one round per clock in 11 cycles. In this case, a clock period for one-round processing must be set such that one-round encryption processing is executed within at least 128/(11×1×10⁹)=11.6 ns. Considering that key data round processing and input data round processing are time-divisionally executed in the above one-round processing interval, each step must be executed within a time equal to or less than ½ the processing interval. A recently released high-speed reconfiguration processor operates at a maximum of 166 MHz, and implements reconfiguration at one clock (6 ns). Therefore, using such a high-speed dynamic reconfiguration means makes it possible to dynamically reconfigure different processing circuits for the first and second halves of a round processing period like that described above. Therefore, a throughput of almost 1 Gbps can be attained.

As described above, the arrangement according to this embodiment can achieve a greater reduction in circuit size than in the arrangement of the first embodiment, and at the same time, can execute high-speed processing. In addition, low power consumption can be achieved by executing encryption processing by hardware.

Note that the dynamic reconfiguration means used in the arrangement according to this embodiment is not limited to that in the embodiment shown in FIG. 2 as long as the above requirement for high-speed processing can be satisfied. Obviously, therefore, it suffices to use other architectures for the internal arrangement of the dynamic reconfiguration circuit, the arrangements of the control unit and reconfiguration information storage unit, and the like.

In this embodiment, the processing circuits for both the key data round processing unit and the input data round processing unit are dynamically reconfigured in different intervals in accordance with the encryption/decryption operation mode. However, circuits to be dynamically reconfigured are not limited to them. Obviously, processing circuits corresponding to processing steps, of the steps executed in encryption/decryption processing, which are executed in different intervals may be targets for dynamic reconfiguration. For example, in the AES encryption circuit, processing circuits corresponding to two or more different steps, of the steps in input data processing, which are executed in different intervals may be set as targets for dynamic reconfiguration. Note that input data processing steps include a ShiftRows step, SubBytes step, MixColumns step, and AddRoundKey step.

In this embodiment, the processing intervals for switching dynamic reconfiguration are the first and second halves of a round processing period. However, the processing intervals for switching dynamic reconfiguration are not limited to them. Obviously, in accordance with two or more different encryption processing steps, of the encryption/decryption processing steps, which are executed in different processing intervals, corresponding processing circuits may be dynamically reconfigured in each processing interval.

In this embodiment, the processing circuits for both the key data round processing unit 802 and the input data round processing unit 801 are dynamically reconfigured in different intervals. This, however, does not necessarily mean that each circuit is dynamically reconfigured entirely. That is, the embodiment may be configured as follows. First of all, a common portion between the key data round processing unit 802 and the input data round processing unit 801 is prepared as a common circuit in advance. A difference circuit between the common circuit and the key data round processing unit 802 and a difference circuit between the common circuit and the input data round processing unit 801 are dynamically reconfigured. For example, an inverse element computing circuit in SubBytes or InvSubBytes may be prepared statically as a common circuit, and only an affine transformation circuit and inverse affine transformation circuit which differ in SubBytes and InvSubBytes may be dynamically reconfigured.

<<Third Embodiment>>

In the arrangements according to the first and second embodiments, a processing circuit to be dynamically reconfigured in a predetermined processing interval is determined in advance. However, a processing circuit to be dynamically reconfigured in a predetermined processing interval may be determined on the basis of a predetermined index. Such indices include, for example, a processing load, throughput, cryptographic intensity, encryption or decryption processing purpose, encryption operation mode (e.g., any one of ECB, CBC, CFB, OFB, and CTR), power consumption, circuit size, and the like.

In addition, a control method of dynamically reconfiguring a predetermined processing circuit in each processing interval may be determined on the basis of a predetermined index.

As an example of this arrangement, an arrangement will be described, in which it is determined, on the basis of level information indicating a level required for each index, how much importance should be placed on which index, and reconfiguration is performed upon selecting a corresponding circuit arrangement and a clock frequency. Such an index includes a throughput (i.e., high-speed processing), cryptographic intensity, power consumption, circuit size, and the like.

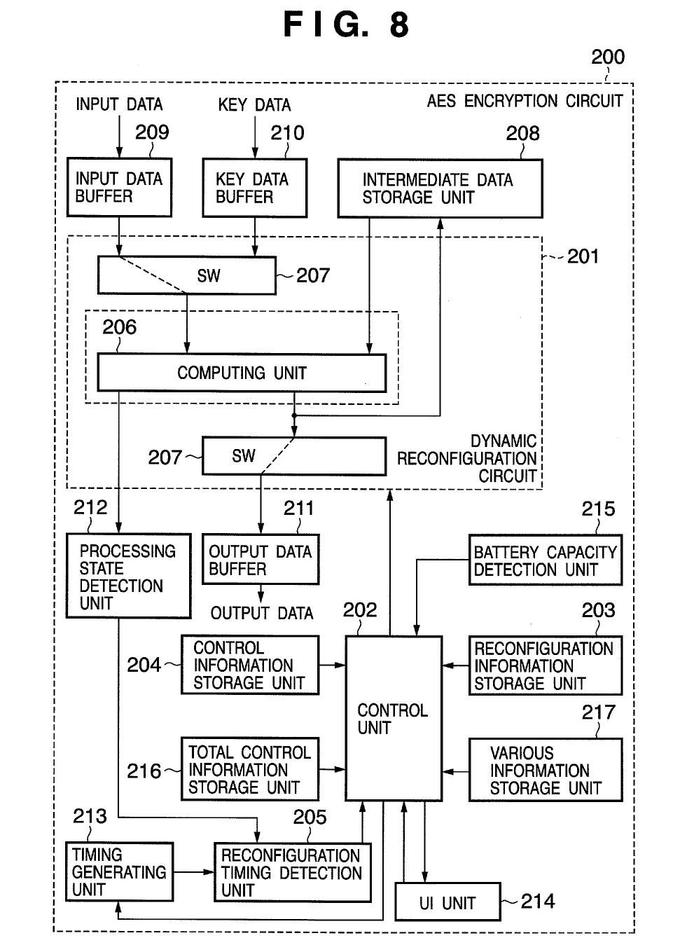

The basic arrangement of the cryptographic processing apparatus according to this embodiment is basically the same as that in FIG. 2 showing the arrangement according to the first and second embodiments. FIG. 8 is a view showing the arrangement of the main part of the cryptographic processing apparatus according to this embodiment, and also shows an arrangement associated with dynamic reconfiguration and the overall cryptographic processing apparatus as well as the arrangement shown in FIG. 2. Note that in this embodiment, the control unit 202 controls not only the dynamic reconfiguration circuit but also circuit portions other than the cryptographic circuit, e.g., the timing circuit, battery circuit, and user interface (UI), and also controls applications including an application for cryptographic processing. Only a portion different from that shown in FIG. 2 will be described below.

Referring to FIG. 8, reference numeral 212 denotes a processing state detection unit which detects the processing state of a dynamic reconfiguration circuit 201, e.g., detects that data round processing is being performed or key round processing is being performed; and 213, a timing generating unit which can, for example, increase and decrease a clock frequency under the control of a control unit 202. More specifically, such control can be realized by providing a frequency dividing circuit in the timing generating unit 213 and controlling the frequency dividing ratio of the frequency dividing circuit. Reference numeral 214 denotes a UI unit which is implemented by key input, a liquid crystal display unit, and the like, and is used by the user to input/output information; 215, a battery capacity detection unit which detects the capacity (remaining capacity) of a battery when the cryptographic processing apparatus is a portable apparatus or the like and uses the battery as a power supply; 216, a total control information storage unit which stores application programs including a program for cryptographic processing, and various kinds of control programs such as programs for timing control, battery control, and UI; and 217, a various information storage unit which stores various kinds of data, e.g., application data, UI data, battery capacity data, and index-arrangement/clock correspondence information.

Outputs from the processing state detection unit 212 and timing generating unit 213 are input to a reconfiguration timing detection unit 205. The reconfiguration timing detection unit 205 detects a reconfiguration timing on the basis of these inputs. For example, the reconfiguration timing can be controlled on the basis of the timing of a change in the state of the dynamic reconfiguration circuit from a key round processing state to a data round processing state or a predetermined switching timing of a frame signal indicating each processing interval from the timing generating unit. The UI unit 214, battery capacity detection unit 215, total control information storage unit 216, and various information storage unit 217 are connected to the control unit 202.

When a low-speed clock is to be used as an operation clock for the dynamic reconfiguration circuit by controlling the timing generating unit 213, the period of the switching timing of dynamic reconfiguration increases on the basis of the clock. If a high-speed clock is used as an operation clock, the period of the switching timing of dynamic reconfiguration decreases. In addition, the switching timing changes in accordance with the processing cycle of a processing circuit to be reconfigured. If, for example, a processing circuit which executes one round process in one clock cycle is reconfigured, the period of switching timing is ¼ that when a processing circuit which executes one round process in four clock cycles.

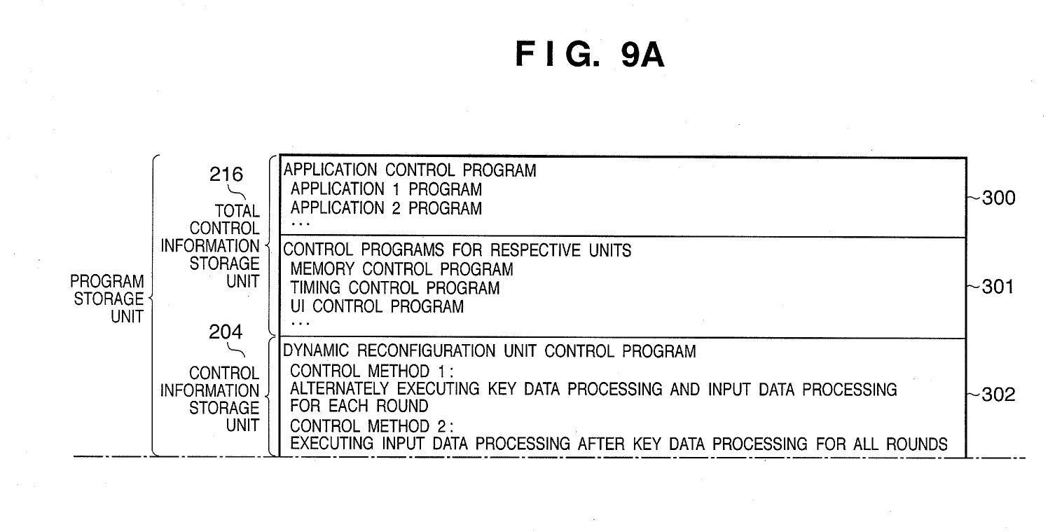

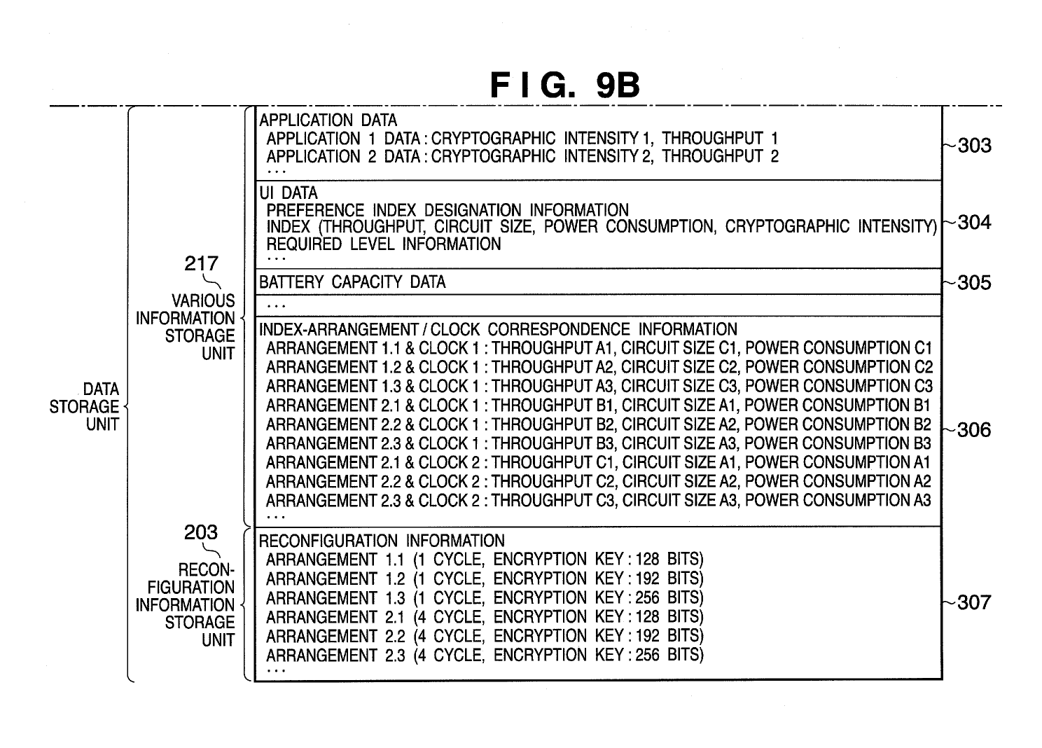

FIGS. 9A and 9B exemplify the pieces of information in the storage units in this embodiment. The storage units can be roughly classified into a program storage unit having the total control information storage unit 216 and control information storage unit 204 and a data storage unit having the various information storage unit 217 and reconfiguration information storage unit 203. Assume that in this embodiment, the pieces of information shown in FIGS. 9A and 9B are stored in the respective storage units 216, 204, 217, and 203.

In this embodiment, the user can designates a circuit arrangement to be dynamically reconfigured and the request levels of the respective indices (e.g., a throughput, cryptographic intensity, power consumption, and circuit size) through the UI unit 214. In addition, the embodiment can be configured to not only select a circuit arrangement to be dynamically reconfigured and a clock frequency by designation through the UI unit 214 but also select a circuit arrangement/clock with low power consumption in accordance with a battery capacity based on information from the battery capacity detection unit 215. Alternatively, a circuit arrangement/clock frequency having a necessary cryptographic intensity/throughput can be selected in accordance with an application to be executed upon being selected by the user through the UI unit 214.

The first and second embodiments have exemplified the case wherein a key data round processing circuit and an input data round processing circuit are alternately and dynamically reconfigured for each round so as to allow an intermediate data storage unit 208 to have a capacity corresponding to only one-round data in consideration of a reduction in circuit size. If, however, the intermediate data storage unit has a capacity that can store data for all rounds, a key data round processing circuit is dynamically reconfigured first to generate round key data for all the rounds, and an input data round processing circuit is then dynamically reconfigured to perform processing in all the rounds. In this case, the number of times of switching of dynamic reconfiguration can be small, and the processing load on the control unit and its power consumption are low. In this embodiment, control method 2 is selected and executed in the dynamic reconfiguration unit control program denoted by reference numeral 302 in FIG. 9A such that input data processing is executed after the execution of key data processing for all the rounds.

Consider a case wherein the UI unit 214 has received, from the user, designation information indicating that more importance is placed on a reduction in power consumption than on throughput, i.e., “the level of throughput is C, and the level of power consumption is A”. Likewise, assume that the user has designated that the bit count of a cryptographic key is 128 bits. In this case, the cryptographic processing apparatus according to this embodiment selects a circuit arrangement and clock suitable for the designation by the user on the basis of index-arrangement/clock correspondence information 306 stored in the various information storage unit 217 in FIG. 9B. That is, in this case, circuit arrangement 2.1 and clock 2 which exhibit the highest level of the power consumption index are selected. Assume that the level of the power consumption index increases in the order of C3, C2, C1, B3, B2, B, A3, A2, and A1. Circuit arrangement 2.1 corresponds to an arrangement with 4 cycles & cryptographic key of 128 bits, and the frequency of a clock increases in the order of clock 2 and clock 1. With this setting, an input data round processing circuit which executes one round process corresponding to 128 bits in four clock cycles by using a small-size circuit for 32-bit processing is dynamically reconfigured, and is operated at a low-speed clock to suppress power consumption.

Consider a case wherein the U1 unit 214 has received designation information indicating that more importance is placed on throughput than on a reduction in power consumption, i.e., “the level of throughput is A, and the level of power consumption is B”, and the user has designated that the bit count of a cryptographic key is 128 bits. In this case, the cryptographic processing apparatus according to this embodiment selects circuit arrangement 1.1 (one cycle & cryptographic key of 128 bits) and clock 1 which exhibit the highest level of the throughput index on the basis of the index-arrangement/clock correspondence information 306 stored in the various information storage unit 217 in FIG. 9B. With this operation, an input data round processing circuit which executes one round process corresponding to 128 bits in one clock cycle with little delay time by using a parallel circuit of four 32-bit processing circuits, although it has a large circuit size, and is operated at a high-speed clock.

In the above two cases, when the user designates a cryptographic key of 256 bits to increase the cryptographic intensity, circuit arrangement 2.3 and circuit arrangement 1.3 are respectively selected.

As described above, since the arrangement according to this embodiment determines a circuit to be dynamically reconfigured on the basis of designation information, the arrangement can flexibly respond to various requirements at the time of use and can provide proper circuits.

Note that in the above embodiment, a circuit arrangement is selected on the basis of the index-arrangement/clock correspondence information 306 stored in the various information storage unit 217 shown in FIG. 9B and designation indicating that importance is placed on a predetermined index. However, an index designation method to be used is not limited to this. For example, it suffices to designate the identification information of an index on which importance is to be placed, designate the identification information of a desired level together with the identification information of an index on which importance is to be placed, or designate the identification information of a circuit arrangement with the known correspondence between each index level and each circuit arrangement.

In addition, this embodiment is configured to cause the control unit 202, which controls dynamic reconfiguration, to control each unit of the cryptographic processing apparatus and the overall apparatus. Obviously, however, different control units may be provided for each unit of the cryptographic processing apparatus and the overall apparatus. Note that this embodiment is configured to control the clock rate in the timing generating unit outside the dynamic reconfiguration circuit. However, a frequency dividing circuit which controls a clock may be provided. inside or outside the dynamic reconfiguration circuit 201.

Furthermore, in this embodiment, the dynamic reconfiguration control method is not changed on the basis of an index. However, it suffices to select not only a combination of a circuit arrangement and a clock but also a combination of a circuit arrangement, a clock, and a control method on the basis of an index by using part of the index-arrangement/clock correspondence information 306 as index-arrangement/clock/control method information.

Note that this embodiment has exemplified the following two circuit arrangements:
the input data round processing circuit which executes 128-bit data round processing in four clock cycles by using the 32-bit processing circuit; and
the input data round processing circuit which executes 128-bit data round processing in one clock cycle by using the parallel circuit of four processing circuits.

Obviously, however, the present invention can use circuit arrangements other than these examples.

As has been described above, the present invention can provide a technique associated with an encryption/decryption processing circuit which can satisfy requirements for high-speed processing, low power consumption, and small gate size.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Application No. 2005-252483, filed Aug. 31, 2005, and Japanese Application No. 2006-183850, filed Jul. 3, 2006 which are hereby incorporated by reference herein in their entirety.

What is claimed is:

1. A cryptographic processing apparatus which executes predetermined cryptographic processing for data, comprising:
a holding unit adapted to hold the data of a processing target;
an intermediate data holding unit adapted to hold information generated during the cryptographic processing as intermediate data;
a circuit reconfiguration processor which reconfigures a first circuit which generates round key information on the basis of at least one of the intermediate data and the key information, in accordance with input of first control information, and reconfigures a second circuit which performs operation processing on the basis of at least one of the data and the intermediate data and the round key information, in accordance with input of second control information; and
a control unit adapted to output the first control information to said circuit reconfiguration processor at a first timing, and output the second control information to said circuit reconfiguration processor at a second timing,
wherein the intermediate data includes at least one of the round key information generated in the first circuit and data of a result of operation processing performed in the second circuit, and
the data of the result of the operation processing performed in the second circuit is output as a result of cryptographic processing.

2. The apparatus according to claim 1, wherein said control unit reconfigures an i-th circuit which executes each of not less than two n cryptographic processes which need not be performed simultaneously at each i-th timing of n timings which falls within a predetermined period, in accordance with input of i-th control information.

3. The apparatus according to claim 1, wherein the cryptographic processing is one of encryption processing and decryption processing of a common key cryptosystem.

4. The apparatus according to claim 1, wherein the cryptographic processing is one of encryption processing and decryption processing of a common key cryptosystem which includes a round key generation step and a data round processing step.

5. The apparatus according to claim 1, wherein the first timing and the second timing each are generated a predetermined number of times at predetermined time intervals.

6. The apparatus according to claim 1, wherein the first circuit and the second circuit each are a circuit corresponding to a difference of a circuit corresponding to each process included in the encryption processing.

7. A cryptographic processing apparatus which executes predetermined cryptographic processing for data, comprising:
a holding unit adapted to hold the data of a processing target, key information, and designation information indicating one of encryption and decryption;
an intermediate data holding unit adapted to hold information generated during the cryptographic processing as intermediate data;
a circuit reconfiguration processor which reconfigures, in accordance with input of first control information, a first circuit which generates first round key information on the basis of at least one of the intermediate data and the key information, reconfigures, in accordance with input of second control information, a second circuit which performs encryption processing on the basis of at least one of the data and the intermediate data and the first round key information, reconfigures, in accordance with input of third control information, a third circuit which generates second round key information on the basis of at least one the intermediate data and the key information, and reconfigures, in accordance with input of fourth control information, a fourth circuit which performs decryption processing on the basis of at least one of the data and the intermediate data and the second round key information; and
a control unit adapted to output the first control information to said circuit reconfiguration processor at a first timing and output the second control information to said circuit reconfiguration processor at a second timing when the designation information designates encryption, and to output the third control information to said circuit reconfiguration processor at a first timing and output the fourth control information to said circuit reconfiguration processor at a second timing when the designation information designates decryption,
wherein the intermediate data includes at least one of the round key information generated in the first circuit, data of a result of operation processing performed in the second circuit, the round key information generated in the third circuit, and data of a result of operation processing performed in the fourth circuit, and
data of a result of operation processing performed in the second circuit and data of a result of operation processing performed in the fourth circuit are output as a result of cryptographic processing.

8. The apparatus according to claim 1, wherein said circuit reconfiguration processor reconfigures the circuit within a predetermined time in accordance with input of the control information.

9. The apparatus according to claim 1, wherein the cryptographic processing is based on an AES algorithm.

10. The apparatus according to claim 1, wherein said control unit determines at least one of the control information output from said circuit reconfiguration processor and at least one of the first timing and the second timing on the basis of an index defined in advance.

11. The apparatus according to claim 10, wherein the index is at least one of a processing load, throughput, cryptographic intensity, operation mode, power consumption, and circuit size.

12. The apparatus according to claim 11, wherein the operation mode includes at least one of ECB, CBC, CFB, OFB, and CTR.

13. The apparatus according to claim 10, further comprising a reception unit adapted to receive a designation associated with the index from a user, wherein said control unit performs the determination on the basis of the designation received by said reception unit.

14. The apparatus according to claim 13, further comprising a storage unit adapted to store information indicating a correspondence relation between a designation associated with the index and reconfiguration control information indicating at least one of a circuit arrangement, a clock rate, and a reconfiguration control method,
wherein said control unit refers to the reconfiguration control information corresponding to the designation received by the reception unit and performs the determination oh the basis of the reconfiguration control information.

15. The apparatus according to claim 13, wherein the designation associated with the index includes a designation of a required level of an index.

16. The apparatus according to claim 10, further comprising a detection unit adapted to detect a predetermined apparatus state,
wherein said control unit performs the determination on the basis of the apparatus state detected by said detection unit.

17. The apparatus according to claim 16, wherein the apparatus state includes at least one of a battery remaining capacity, a cryptographic intensity used for an execution application, and a throughput.

18. The apparatus according to claim 10, wherein when said reception unit receives a designation indicating a high throughput, said control unit performs the determination so as to dynamically reconfigure a circuit which operates at a high-speed clock with little delay and a small number of cycles.

19. The apparatus according to claim 10, wherein when said reception unit receives a designation indicating a low power consumption, said control unit performs the determination so as to dynamically reconfigure a small-size circuit which operates at a low-speed clock.

20. The apparatus according to claim 10, wherein when said detection unit detects that a battery remaining capacity is not more than a predetermined capacity, said control unit performs the determination so as to dynamically reconfigure a small-size circuit which operates at a low-speed clock.

21. The apparatus according to claim 10, wherein when said detection unit detects a cryptographic intensity used for an execution application, said control unit performs the determination so as to dynamically reconfigure a circuit which processes cryptographic key bit count corresponding to the cryptographic intensity.

22. The apparatus according to claim 10, wherein when said detection unit detects a throughput used for an execution application, said control unit performs the determination so as to dynamically reconfigure a circuit which performs processing with a delay, cycle count, and clock rate which correspond to the throughput.
